(19) United States
(12) Patent Application Publication
(10) Pub. No.: US 2024/0307253 A1
(43) Pub. Date: Sep. 19, 2024

(54) MASSAGE APPARATUS

(71) Applicant: SAMSUNG ELECTRONICS CO., LTD., Suwon-si (KR)

(72) Inventor: Daesung KI, Suwon-si (KR)

(73) Assignee: SAMSUNG ELECTRONICS CO., LTD., Suwon-si (KR)

(21) Appl. No.: 18/541,911

(22) Filed: Dec. 15, 2023

Related U.S. Application Data
(63) Continuation of application No. PCT/KR2023/019696, filed on Dec. 1, 2023.

(30) Foreign Application Priority Data
Mar. 15, 2023 (KR) 10-2023-0034156

(51) Int. Cl. A61H 15/00

(52) U.S. Cl. CPC A61H 15/0078; A47C 17/16; A61H 2201/0107; A61H 2201/0149; A61H 2201/1654; A61H 2201/5025

(57) ABSTRACT

A massage apparatus including a seat portion with a first side and a second side opposite the first side, the seat portion including a seat frame, and a seat on the first side of, and coupled to, the seat frame; a base frame on the second side of the seat portion, and including an opening; a massage module coupled to the base frame, and configured to provide a massage function through the opening; and a cover member on the second side of the seat portion, wherein the cover member is configured to be movable to cover the opening and uncover the opening.

### FIELD

The disclosure relates to a massage apparatus.

### DESCRIPTION OF THE RELATED ART

In general, massage apparatuses are apparatuses that are provided for a user to receive a massage while seated, providing a massage to an entire body of the user.

A massage apparatus includes a massage module for providing a massage to a user's body therein. The massage module performs a massage by applying appropriate pressure to the user's body through rotational and reciprocating motions.

The massage apparatus may typically be provided as a chair-type massage apparatus or a bed-type massage apparatus. Recently, there has been a demand for a massage apparatus that may be used as a chair-type, but may also be changed to a bed-type depending on the user's needs.

On the other hand, although the user is not receiving a massage on the massage apparatus, a seat portion formed of a seat and the massage module are in direct contact with each other, causing the user not to rest comfortably.

### SUMMARY

The disclosure is directed to providing a massage apparatus that allows a user to relax comfortably because no pressure is applied to the user by a massage module even when the user is not receiving the massage.

Further, the disclosure is directed to providing a massage apparatus that allows a user to relax comfortably while not receiving a massage, regardless of a chair mode and/or a bed mode.

Technical tasks to be achieved in this document are not limited to the technical tasks mentioned above, and other technical tasks not mentioned will be clearly understood by those skilled in the art from the description below.

Aspects of embodiments of the disclosure will be set forth in part in the description which follows and, in part, will be apparent from the description, or may be learned by practice of the presented embodiments.

According to an embodiment of the disclosure, a massage apparatus includes a seat portion with a first side and a second side opposite the first side, the seat portion including a seat frame, and a seat on the first side of, and coupled to, the seat frame; a base frame on the second side of the seat portion, and including an opening; a massage module coupled to the base frame, and configured to provide a massage function through the opening; and a cover member on the second side of the seat portion, wherein the cover member is configured to be movable to cover the opening and uncover the opening.

According to an embodiment of the disclosure, the cover member may be movable between a first position that opens the opening so that the massage module is movable through the opening, and a second position that closes the opening.

According to an embodiment of the disclosure, the cover member may include a first cover member disposed on a first side of the opening along a left-right direction when the cover member is at the first position, and a second cover member disposed on a second side of the opening along the left-right direction when the cover member is at the first position.

According to an embodiment of the disclosure, each of the first cover member and the second cover member may be rotatable so as to be moved from the first position to the second position.

According to an embodiment of the disclosure, each of the first cover member and the second cover member may be slidable so as to be moved from the first position to the second position.

According to an embodiment of the disclosure, the cover member may be folded at a first end of the opening when the cover member is at the first position, and may be unfolded from the first end of the opening towards a second end of the opening when the cover member is at the second position.

According to an embodiment of the disclosure, when the cover member is at the second position, the cover member may be located at a first end of the opening, and the massage module may be located at a second end of the opening.

According to an embodiment of the disclosure, at the second position, the cover member may be disposed between the seat portion and the massage module so as to cover the massage module.

According to an embodiment of the disclosure, the cover member may include a first cover member spaced apart from the opening, a second cover member between the first cover member and the seat portion, and a connecting member disposed between the first cover member and the second cover member to connect the first cover member and the second cover member.

According to an embodiment of the disclosure, the massage apparatus may further include a drive device configured to move the cover member to the first position to uncover the opening in a massage-on mode, and move the cover member to the second position to cover the opening in a massage-stop mode.

According to an embodiment of the disclosure, the massage apparatus may further include a controller configured to switch the drive device to the massage-on mode and the massage-stop mode based on a user input.

According to an embodiment of the disclosure, the controller may be configured to move the cover member from the first position to the second position in response to switching from the massage-on mode to the massage-stop mode.

According to an embodiment of the disclosure, the massage apparatus may further include a drive device configured to move the cover member to a first position to uncover the opening in a massage-on mode, and move the cover member to a second position to cover the opening in a massage-stop mode; and a controller configured to control, in response to switching from the massage-on mode to the massage-stop mode, the drive device to extend the connecting member toward the opening so that the second cover member covers the opening.

### BRIEF DESCRIPTION OF THE DRAWINGS

These and/or other embodiments of the disclosure will become apparent and more readily appreciated from the following description of embodiments, taken in conjunction with the accompanying drawings of which:

FIG. 1 is a perspective view illustrating a massage apparatus according to an embodiment of the disclosure.

FIG. 2 is a perspective view illustrating the massage apparatus according to an embodiment of the disclosure.

FIG. 3 is an exploded perspective view illustrating the massage device according to an embodiment of the disclosure.

FIG. 4 is an exploded perspective view illustrating a portion of the massage apparatus according to an embodiment of the disclosure.

FIG. 5 is a schematic view illustrating the massage apparatus according to an embodiment of the disclosure.

FIG. 6 is a schematic view illustrating the massage apparatus according to an embodiment of the disclosure.

FIG. 7 is a schematic view illustrating the massage apparatus according to an embodiment of the disclosure.

FIG. 8 is a schematic view illustrating the massage apparatus according to an embodiment of the disclosure.

FIG. 9 is a schematic view illustrating the massage apparatus according to an embodiment of the disclosure.

FIG. 10 is a schematic view illustrating the massage apparatus according to an embodiment of the disclosure.

FIG. 11 is a schematic view illustrating the massage apparatus according to an embodiment of the disclosure.

FIG. 12 is a schematic view illustrating the massage apparatus according to an embodiment of the disclosure.

FIG. 13 is a side cross-sectional view illustrating the massage apparatus according to an embodiment of the disclosure.

FIG. 14 is a side cross-sectional view illustrating the massage apparatus according to an embodiment of the disclosure.

FIG. 15 is a side cross-sectional view illustrating the massage apparatus according to an embodiment of the disclosure.

FIG. 16 is a side cross-sectional view illustrating the massage apparatus according to an embodiment of the disclosure.

FIG. 17 is a control block diagram illustrating the massage apparatus according to an embodiment of the disclosure.

### DETAILED DESCRIPTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms first, second, primary, secondary, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In addition, as used in the disclosure, the meaning of “identical” may include having similar properties or being similar within a certain range. Also, identical may include “substantially the same”. Substantially the same should be understood to include within the scope of “identical” figures that fall within a margin of error in manufacturing, or figures that fall within a margin of difference that is not meaningful with respect to a reference figure.

Furthermore, terms such as “part”, “unit”, “block”, “member”, “module”, and the like may refer to a unit that processes at least one function or operation. For example, these terms may refer to at least one piece of hardware, such as a field-programmable gate array (FPGA)/an application specific integrated circuit (ASIC), at least one piece of software stored in memory, or at least one process processed by a processor.

Meanwhile, in the disclosure, for ease of description, a first direction X may be referred to as a front-back direction, a second direction Y may be referred to as a left-right direction, and a third direction C may be referred to as an up-down direction. However, the terms “front”, “rear”, “left”, “right”, and the like used in the following description are defined based on the drawings, and the shape and location of each component may not be limited by these terms.

Hereinafter, an embodiment according to the disclosure will be described in detail with reference to the accompanying drawings.

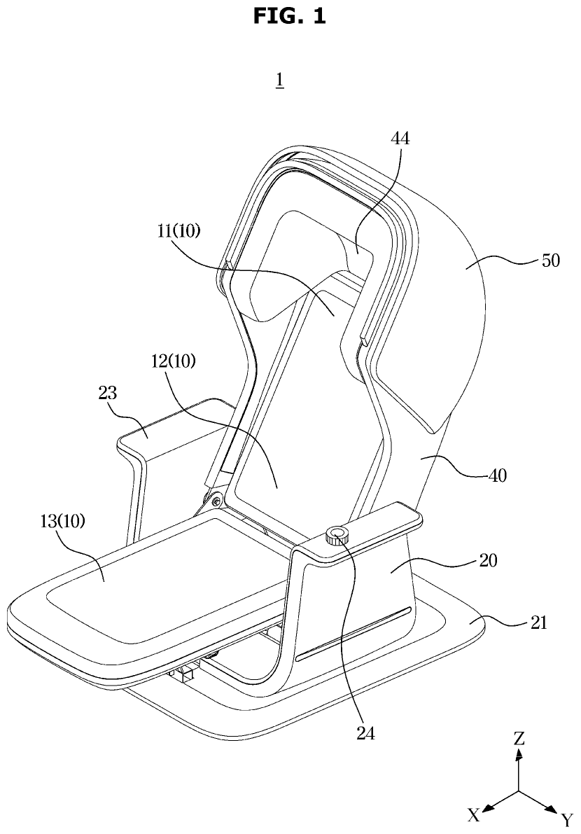

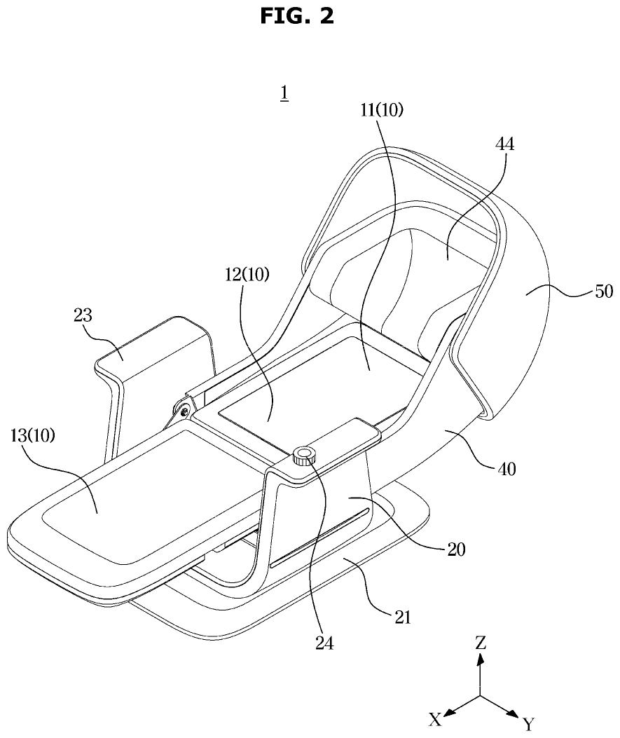

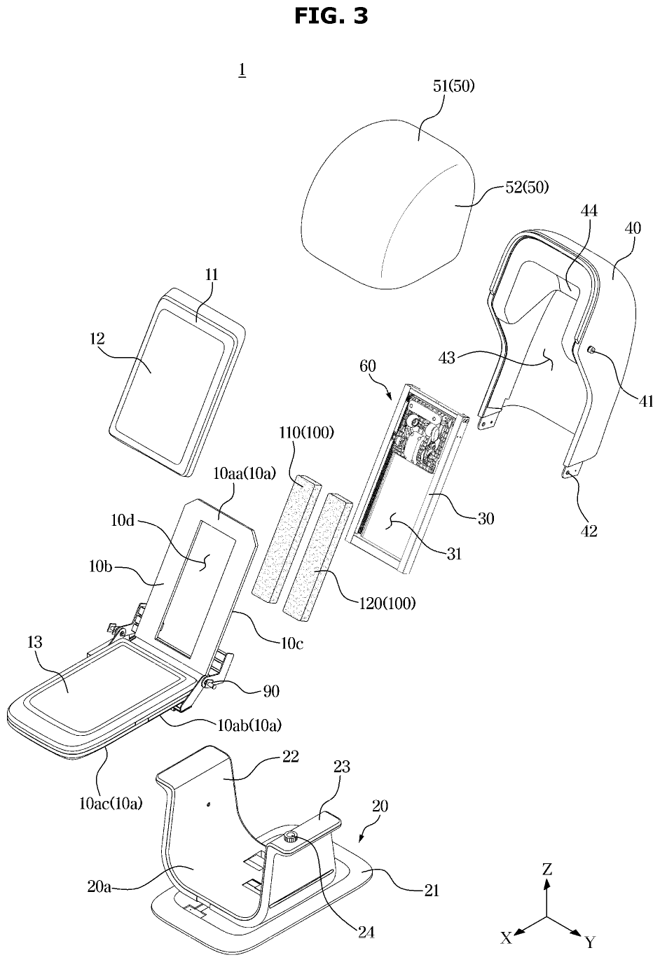

FIG. 1 is a perspective view illustrating a massage apparatus according to an embodiment of the disclosure. FIG. 2 is a perspective view illustrating the massage apparatus according to an embodiment of the disclosure. FIG. 3 is an exploded perspective view illustrating the massage apparatus according to an embodiment of the disclosure.

Referring to FIGS. 1 to 3, a massage apparatus 1 may be an apparatus for providing a massage to a user. The massage apparatus 1 may be realized in the form of a chair so that the user may relax. The massage apparatus 1 may be covered with a leather or fabric material that may be in contact with the user's skin. As a result, such a soft material may come into contact with the user's skin, so that the user may feel psychologically stable.

FIG. 1 shows the massage apparatus when used in a chair mode, and FIG. 2 shows the massage apparatus when used in a bed mode. The massage apparatus according to an embodiment may be freely transformed from the chair mode to the bed mode or from the bed mode to a massage type structure.

The massage apparatus according to an embodiment may provide a massage function regardless of the chair mode or the bed mode.

The massage apparatus 1 may include a seat portion 10 for supporting the user. The seat portion 10 may include a seat frame 10a that forms a framework of the seat portion 10. The seat frame 10a may extend so as to support from the user's head to an upper body and a lower body. The seat portion 10 may be covered on the seat frame 10a, and may be referred to as including a first seating portion 11, a second seating portion 12, and a third seating portion 13.

The seat portion 10 may include a first side 10b and a second side 10c opposite to the first side 10b. For example, while the massage apparatus is in the chair mode, the first side 10b may be a front side and the second side 10c may be a rear side. The first side 10b and the second side 10c of the seat portion 10 may be the first side 10b and the second side 10c of the seat frame 10a. The seating portions 11, 12, and 13 may be arranged on the first side 10b.

The seat frame 10a may include a first seat frame 10aa, a second seat frame 10ab, and a third seat frame 10ac. For example, the first seat frame 10aa may support the upper body and a portion of the buttocks. The second seat frame 10ab may support the buttocks and thigh sides of the lower body. The third seat frame 10ac may support the calf and foot sides of the lower body.

The first seat frame 10aa and the second seat frame 10ab may be rotatably coupled. The first seat frame 10aa and the second seat frame 10ab may be coupled by a rotation support frame 90. The second seat frame 10ab and the third seat frame 10ac may be rotatably coupled. Although not shown in the drawings, the user may freely adjust and use the second seat frame 10ab and the third seat frame 10ac, which support the lower body.

For example, in the chair mode of the massage apparatus, the first seat frame 10aa may be coupled at an upper portion of the second seat frame 10ab and be disposed at a rear side of the second seat frame 10ab. In addition, in the bed mode of the massage apparatus, the first seat frame 10aa may be disposed at the rear side of the second seat frame 10ab.

The first seat frame 10aa may support the first seating portion 11 and the second seating portion 12, and the second seat frame 10ab may support the third seating portion 13. The first seat frame 10aa may be formed integrally with the first seating portion 11 and the second seating portion 12. The second seat frame 10ab may be formed integrally with the third seating portion 13.

The seat portion 10 may include the seating portions 11, 12, and 13. The seating portions 11, 12, and 13 may be provided on one side of the seat portion 10. For example, the seating portions 11, 12, and 13 may be provided on a first side of the seat portion 10. For example, the seat frame 10a may be coupled to a front side of a base frame 30 to allow the user's body to be seated and supported. The seating portions 11, 12, and 13 may be referred to as seating surfaces.

The seating portions 11, 12, and 13 may be provided to contact the user's body. For example, the seating portions 11, 12, and 13 may be in contact with a back of the user's body to support the user from behind.

The seating portions 11, 12, and 13 may include a soft material to increase the seating comfort of the user. In addition, the seating portions 11, 12, and 13 may include a deformable material to allow the back of the user's body to be pressed by a massage module 60 located at a rear side of the seat frame 10a. However, the material forming the seating portions 11, 12, and 13 is not limited thereto, and any material which provides comfort to the user is sufficient.

The upper body of the user and the lower body of the user, as described below, may be distinguished based on the user's buttocks.

The seat portion 10 is not limited to what is shown in the drawings, and may be formed to surround the user's head, back, arms, legs, and buttocks, respectively. The massage module 60 may be provided on one side of the seat portion 10 so as to provide a massage to the user.

The seat portion 10 may include the first seating portion 11, the second seating portion 12, and the third seating portion 13. The first seating portion 11 may support a portion of the user's head, the entire head, and the upper body. The second seating portion 12 may be coupled to one end of the first seating portion 11. For example, while the massage apparatus is used in the chair mode, the second seating portion 12 may be connected to the first seating portion 11 and thus positioned below the first seating portion 11. The second seating portion 12 may be provided to support a portion of a rear side of the buttocks of the lower half of the user's body.

The third seating portion 13 may be coupled to one end of the second seating portion 12. For example, while the massage apparatus is used in the chair mode, the third seating portion 13 may be connected to the second seating portion 12 and thus positioned below the second seating portion 12. The third seating portion 13 may be provided to support a portion of the lower half of the user's body or the entire lower half.

For example, the first seating portion 11 and the second seating portion 12 may support a portion or the entire upper half of the user's body, including the user's head, from a rear side of the user. The third seating portion 13 may support a portion or the entire lower half of the user's body from the rear side of the user.

The second seating portion 12 may be rotatably coupled to the third seating portion 13 to allow the angle at which the second seating portion 12 supports the user's upper body to be adjusted. For example, the second seating portion 12 may be provided to be rotatable forward and backward with respect to the third seating portion 13 based on a point where the second seating portion 12 is connected to the third seating portion 13.

However, the disclosure is not limited thereto, and the second seating portion 12 may be secured to the third seating portion 13 so as not to be non-rotatable.

The third seating portion 13 may be provided to support the user's thighs and calves. For example, while the massage apparatus is used in the chair mode, the third seating portion 13 may support the user from the rear side of the user.

However, although not shown in the drawings, a portion supporting the user's calf in the third seating portion 13 may be provided in a shape capable of surrounding the user's calf so as to accommodate the user's calf.

The massage apparatus 1 may include the rotation support frame 90. The rotation support frame 90 may allow the seat frame to be rotated.

The massage apparatus 1 may include a leg 20 provided to support the seat portion 10 and the base frame 30. The leg 20 may be coupled below the seat frame 10a and the base frame 30.

The leg 20 may be provided on the left, on the right, and under the seat frame 10a and the base frame 30. The leg 20 is not limited to that shown in the drawings and may be provided as at least one or more legs, and may be formed as a separate element on the base frame 30.

The leg 20 may include a support portion 20a, a floor 21, a wing portion 22, and an armrest portion 23.

The support portion 20a may support the seat frame 10a, the base frame 30, and the rotation support frame 90 below the seat frame 10a, the base frame 30, and the rotation support frame 90.

The floor 21 may be disposed below the support portion 20a, the wing portion 22, and the armrest portion 23. The floor 21 may have a flat shape so that the massage apparatus may be supported from the ground.

The wing portion 22 may extend outwards from the support portion 20a on both sides. The wing portion 22 may extend upward from the support portion 20a. A lower end of the wing portion 22 may be connected to the support portion 20a.

The armrest portion may be connected to an upper portion of the wing portion 22. The armrest portion 23 may extend along a front-back direction. In addition, the armrest portion 23 may extend along a left-right direction. The armrest portion 23 may extend from the support portion 20a in an outward direction. The armrest portion 23 may be disposed on opposite sides of the support portion 20a.

The massage apparatus may include a user interface 24. The user interface 24 may be provided on the armrest portion 23. The user interface 24 may be manipulated by the user to operate the massage apparatus in a massage-on mode or a massage-stop mode. Furthermore, the user may manipulate the user interface 24 to cause the shape of the massage apparatus to be in the chair mode or in the bed mode. The user interface 24 may be referred to as an operating device 24. The user interface 24 may be provided to be rotatable, and the user may rotate the user interface 24 to input instructions to the massage apparatus. The user interface 24 may include an input interface and an output interface, respectively.

The shape of the legs 20 is not limited to the above examples.

The base frame 30 may be located on one side of the seat frame 10a. For example, while the massage apparatus is used in the chair mode, the base frame 30 may be positioned below and behind the seat frame 10a. In addition, while the massage apparatus is used in the bed mode, the base frame may be positioned below the seat frame 10a.

The massage apparatus may include a rear frame 40. While the massage apparatus is used in the chair mode, the rear frame 40 may be disposed on the rear side of the seat frame 10a and the base frame 30. In addition, while the massage apparatus is used in the bed mode, the rear frame 40 may be disposed below the seat frame 10a and the base frame 30.

The rear frame 40 may be provided to surround the seat frame 10a and the base frame 30. The rear frame 40 may surround the user while the user is using the massage apparatus. The rear frame 40 may be referred to as the rear cover 40.

A cover coupling portion 41 may be formed on opposite sides of the rear frame 40 to rotatably couple the rear frame 40 to a cover 50. The cover coupling portion 41 may be included in the rear frame 40.

A frame coupling portion 42 may be formed at a lower portion of the rear frame 40 to rotatably couple the rear frame 40 and the seat frame 10a by means of the rotation support frame 90. The frame coupling portion 42 may also be included in the rear frame 40.

An accommodation space 43 may be formed within the rear frame 40. When the rear frame 40 is coupled with the seat portion 10 and the base frame 30, the accommodation space 43 may accommodate at least the user's head and/or a portion of the upper half of the user's body. In addition, the base frame 30 may be accommodated in the accommodation space 43.

The rear frame 40 may include a seating portion 44. The seating portion 44 of the rear frame 40 may be a head seating portion 44 or a face seating portion 44 for supporting a back side of the user's head. The seating portion 44 of the rear frame 40 may be covered by the cover while the cover is in a second position.

The rear frame 40 and the leg 20 may be included in the base frame 30.

The seat frame 10a, the base frame 30, and the rear frame 30 described above are only examples, and the seat frame 10a, the base frame 30, and the rear frame 30 may be provided in various shapes as long as they support the user's body.

The massage apparatus may include the cover 50. The cover 50 may be rotatably coupled to the rear frame 40. The cover 50 may be rotated by the user by manipulating the user interface 24 as needed. For example, the cover 50 may have a first position, and a second position that is rotated from the first position to cover the first seating portion 11.

The cover 50 may include a first cover portion 51 and a second cover portion 52. The first cover portion 51 may have a certain curvature and form an upper portion of the cover 50. The second cover portion 52 may be provided on the left and right sides of the first cover portion 51. The second cover portion 52 may be coupled to the rear frame 40 to cover both sides of the user. The second portion 52 may be the left and right sides of the cover 50.

The massage apparatus may include the massage module 60. The massage module 60 may be disposed on the second side of the seat frame 10a. The massage module 60 may provide a massage to the user. For example, while the massage apparatus is used in the chair mode, the massage module 60 may be positioned at the rear side of the first seating portion 11 and the second seating portion 12 to provide a massage from the head to the waist of the user. In addition, while the massage apparatus is used in the bed mode, the massage module 60 may be positioned below the first seating portion 11 and the second seating portion 12 to provide a massage from the head to the waist of the user.

Furthermore, the disclosure is not limited thereto, and a separate module capable of providing a massage partially or fully to the lower body of the user may be provided on the seat frame 10a separately from the massage module 60 shown in the drawings.

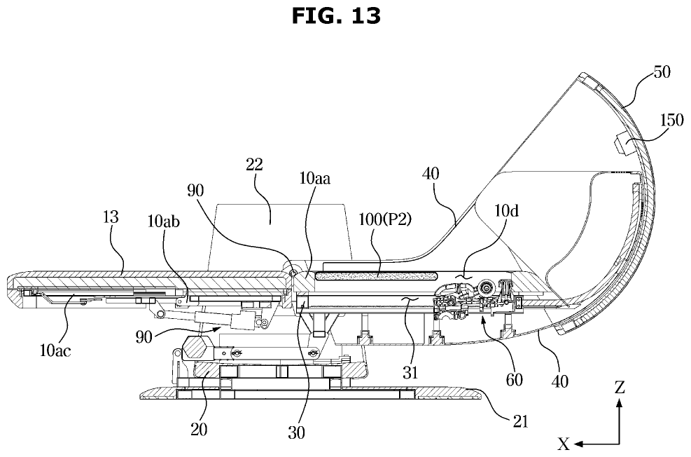

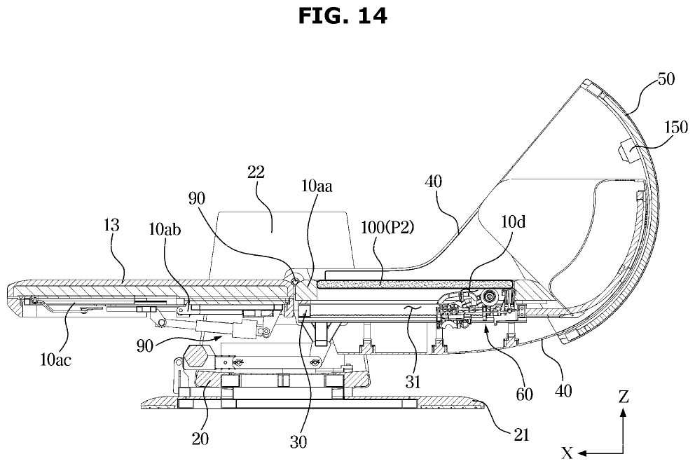

The massage apparatus according to an embodiment may include a cover member 100. The cover member 100 may cover an opening 31 formed in the base frame 30 and an opening 10d formed in the seat frame 10a. The cover member 100 may cover the opening 10d while the user is not receiving a massage, thereby preventing the user from being pressed by the massage module. For example, the cover member 100 may be disposed ahead of the massage module 60 to cover the opening 31 of the base frame 30 (see FIGS. 13 and 14). Also, for example, the cover member 100 may cover the opening 10d of the seat portion 10 (see FIGS. 13 and 14). The cover member 100 may be referred to as an opening/closing member, a barrier member, a support member, a cushioning member, or the like.

The cover member 100 may be disposed on one side of the openings 10d and 31. The cover member 100 may be disposed on the second side 10c of the seat frame 10a. For example, the cover member 100 may be disposed on a rear side of the second seating portion 12 while the massage apparatus is used in the chair mode. In addition, the cover member 100 may be disposed below the first seating portion 11 and the second seating portion 12 while the massage apparatus is used in the bed mode. For example, the cover member 100 may be disposed between the opening 31 formed in the base frame 30 and the opening 10d formed in the seat frame 10a.

Furthermore, the cover member 100 may include various shapes. For example, the cover member 100 may include a panel shape. However, the shape of the cover member 100 is not limited thereto, and may include various shapes as long as the cover member 100 covers the openings 10d and 31.

At least one cover member 100 may be provided. For example, the cover member 100 may include a first cover member 110 and a second cover member 120. The first cover member 110 and the second cover member 120 may be arranged along the left-right direction. Alternatively, it is also possible for the cover member 100 to be formed as a single member.

The cover member 100 may have a first position and a second position. Further details will be described later.

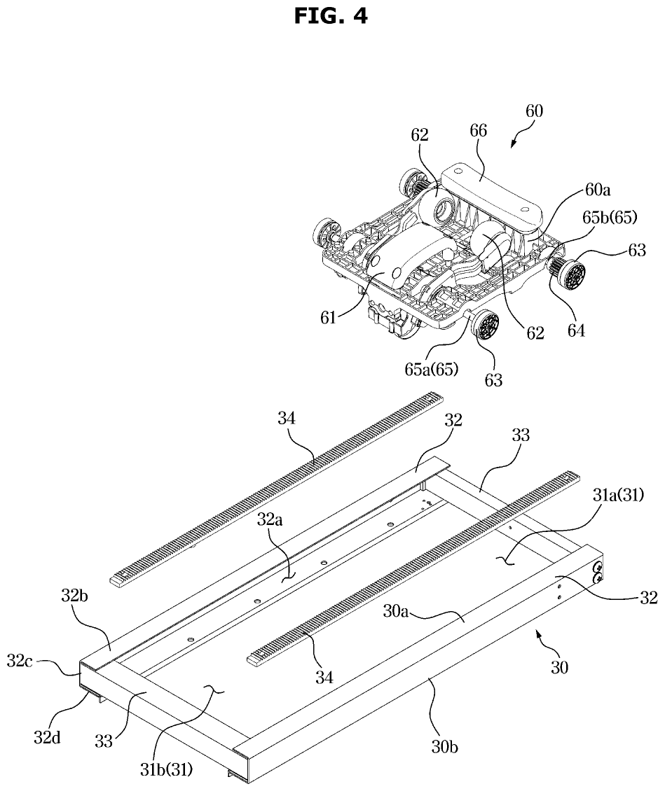

FIG. 4 is an exploded perspective view illustrating a portion of the massage apparatus according to an embodiment of the disclosure.

Referring to FIG. 4, the massage apparatus may include the base frame 30 and the massage module 60.

The base frame 30 may include a first side 30a and a second side 30b. For example, while the massage apparatus is in the chair mode, the first side 30a of the base frame 30 may be a front side, and the second side 30b may be a rear side.

The base frame 30 may include a first base frame 32 and a second base frame 33. The first base frame 32 and the second base frame 33 may each be provided in a plurality. The first base frame 32 and the second base frame 33 may be vertically coupled to each other. The second base frame 33 may be coupled to opposite ends of the first base frame 32. The first base frame 32 may be coupled to opposite ends of the second base frame 33.

The first base frame 32 may include a first panel 32b, a second panel 32c, and a third panel 32d. The first panel 32b and the third panel 32d may be provided in parallel. The second panel 32c may connect the first panel 32b and the third panel 32d. The second panel 32c may be provided perpendicular to the first panel 32b and the third panel 32d. The second panel 32c may connect the ends of the first panel 32b and the third panel 32d.

The first panel 32b, the second panel 32c, and the third panel 32d may form a guide receiving space 32a. The guide receiving space 32a may be provided with a guide rack gear 34. For example, the guide rack gear 34 may be disposed on an inner surface of the third panel 32d facing the guide receiving space 32a. The guide rack gear 34 may guide a movement of the massage module 60. For example, the guide rack gear 34 and a pinion gear 64 of the massage module 60 may be meshed. The guide rack gear 34 may be formed to correspond to the pinion gear 64. The guide rack gear 34 may extend along one direction.

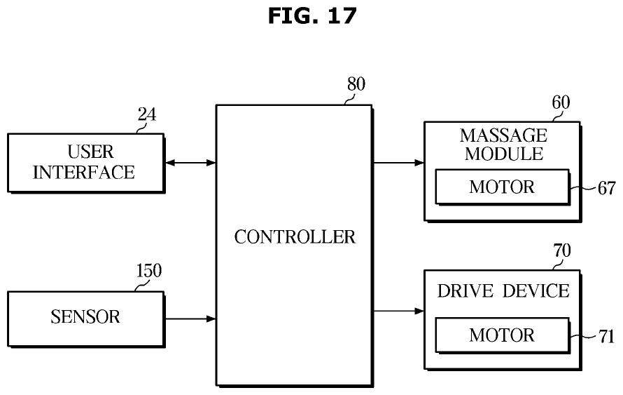

The massage module 60 may provide a massage to the user. The massage module 60 may include a motor 67 (see FIG. 17), a massage roller 62, a moving roller 63, the pinion gear 64, and a drive shaft 65.

The motor 67 may be connected to the drive shaft 65 to transmit power to the massage roller 62 and the moving roller 63. For example, the motor 67 may be connected to a first drive shaft 65a to transmit power to the massage roller 62, thereby allowing the massage module 60 to provide a massage function to the user. In addition, the motor 67 may be connected to the first drive shaft 65a and a second drive shaft 65b to transmit power to the moving roller 63, so that the massage module 60 may be moved within the opening 31 along the guide rack gear 34.

The massage roller 62 may be driven by the motor 67 and the first drive shaft 65a to provide a massage (e.g., a tapping function) to the user. The massage roller 62 may be provided in a plurality.

The moving roller 63 may receive power from the motor 67, the first drive shaft 65a, and the second drive shaft 65b to allow the massage module 60 to move within the opening 31. The moving roller 63 may be disposed within the guide receiving space 32a. The moving roller 63 may be may be provided in a plurality. For example, four moving rollers 63 may be provided. However, the number of moving rollers 63 is not limited to the above examples.

The pinion gear 64 may mesh with the guide rack gear 34 to guide the movement of the massage module 60. The pinion gear 64 may be disposed within the guide receiving space 32a. The pinion gear 64 may be formed to correspond to the guide rack gear 34. The pinion gear 64 may be provided in a plurality.

The drive shaft 65 may transmit power from the motor 67 to the massage rollers 62 and the moving rollers 63. The drive shaft 65 may extend along the left-right direction. The drive shaft 65 may include the first drive shaft 65a and the second drive shaft 65b. The first drive shaft 65a may be connected to the massage rollers 62 and the moving rollers 63. The second drive shaft 65b may be connected to the moving rollers 63 and the pinion gear 64.

The massage module 60 may further include supporters 61 and 66. The supporters 61 and 66 may support the user during the massage-on mode after the user is comfortably reclined or leaned against the massage apparatus. The supporters 61 and 66 may protrude from a body 60a toward the seating portions 11, 12, and 13. The supporters 61 and 66 may include the first supporter 61 and a second supporter 66. While the massage apparatus is in the chair mode, the first supporter 61 may be placed below the second supporter 66. At this time, the first supporter 61 may extend in a vertical direction, and the second supporter 66 may extend in a lateral direction (i.e., the left-right direction). The first supporter 61 and the second supporter 66 may be spaced apart from each other.

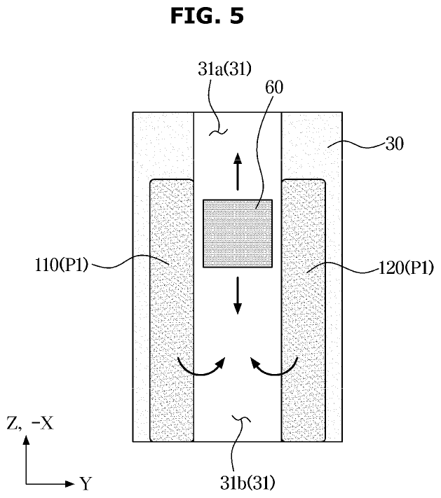

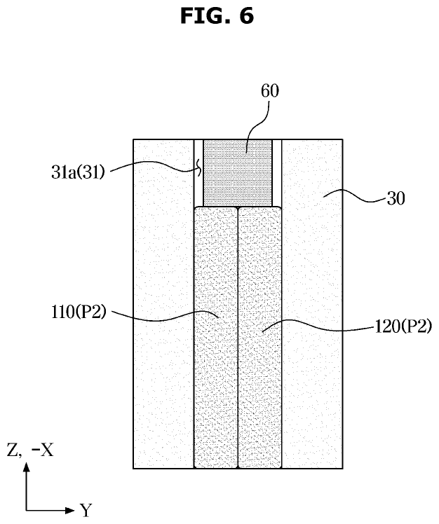

FIG. 5 is a schematic view illustrating the massage apparatus according to an embodiment of the disclosure. FIG. 6 is a schematic view illustrating the massage apparatus according to an embodiment of the disclosure. FIG. 5 is a view of the massage apparatus while the cover member is in the first position, and FIG. 6 is a view of the massage apparatus while the cover member is in the second position.

Referring to FIGS. 5 and 6, the massage apparatus according to an embodiment of the disclosure may include the seat frame 10a, the base frame 30, the massage module 60, and the cover member 100.

The seat frame 10a and the base frame 30 may include openings 10d and 31, respectively. The openings 10d and 31 may be formed in a central portion of each of the seat frame 10a and the base frame 30. For example, the openings 10d and 31 may be provided along the front-back direction. In the massage apparatus according to an embodiment, the massage module 60 may move along the opening 31 of the base frame 30, and the cover member 100 may cover and open/close all the opening 31 of the base frame 30 and the opening 10d of the seat frame 10a. However, for ease of description, the disclosure will be based on the opening 31 of the base frame 30.

The massage module 60 may move along the opening 31 to provide a massage function to the user. For example, while the massage apparatus is used in the chair mode, the massage module 60 may move in the vertical direction within the opening 31. In addition, while the massage apparatus is used in the bed mode, the massage module 60 may move in the front-back direction within the opening 31.

The cover member 100 may cover the opening 31. The cover member 100 may be disposed on the second side 10c of the seat portion 10. The cover member 100 may have the first position P1 and the second position P2. At the first position P1, the cover member 100 may open the opening 31 to allow the massage module 60 to be movable. The cover member 100 may cover the opening 31 at the second position P2. In addition, the cover member 100 may close the opening 31 at the second position P2. In the massage-on mode, the cover member 100 may be located at the first position P1, and in the massage-stop mode, the cover member 100 may be located at the second position P2.

A plurality of cover members 100 may be provided. For example, the cover member 100 may include the first cover member 110 and the second cover member 120.

The first cover member 110 may be disposed on a first side along the left-right direction of the opening 31 at the first position P1. The second cover member 120 may be disposed on a second side along the left-right direction of the opening 31 at the first position P1.

The cover member 100 may be rotated by means of a rotation device (not shown) to cover the opening 31. The rotation device (not shown) may be coupled to the base frame 30 or the seat frame 10a to rotate the cover member 100 so that the cover member 100 opens and closes the opening 31. For example, while the massage apparatus is used in the chair mode, the cover member 100 may be directed backward and then moved forward again toward the opening 31 to cover the opening 31. In addition, while the massage apparatus is used in the bed mode, the cover member 100 may be directed downward and then moved upward again toward the opening 31 to cover the opening 31.

The cover member 100 may be placed at the first position P1 in the massage-on mode to open the opening 31, and may be placed at the second position P2 in the massage-stop mode to close the opening 31. For example, at the second position P2, the cover member 100 may partially close or cover the opening 31. The massage module 60 may be located at one end 31a of the opening 31 while the cover member 100 partially closes the opening 31. For example, while the massage apparatus is used in the chair mode, the massage module 60 may be located at one end 31a (e.g., an upper portion) within the opening 31. In addition, while the massage apparatus is used in the bed mode, the massage module 60 may be located at one end 31a (e.g., a rear end) within the opening 31 (see FIG. 13). The massage module 60 may be located at a position corresponding to the first seating portion 11 at the second position P2 of the cover member 100. At this time, the massage module 60 may provide the user with a pillow function for the user. In addition, the massage module 60 may be adjustable in height to protrude toward the user or away from the user.

The opening 31 is closed in the massage-stop mode, that is, at the second position P2 of the cover member 100, so that the user may not be pressed by the massage module 60 while not receiving a massage. Accordingly, the user may feel comfortable by the massage apparatus during the massage-stop mode. In addition, while the massage apparatus is in the bed mode and the massage-stop mode, the user may lie down on the massage apparatus and sleep comfortably.

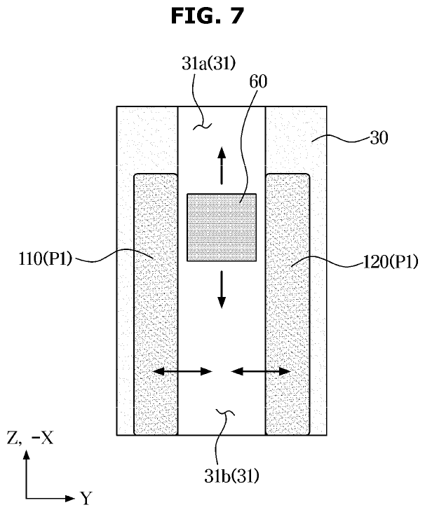

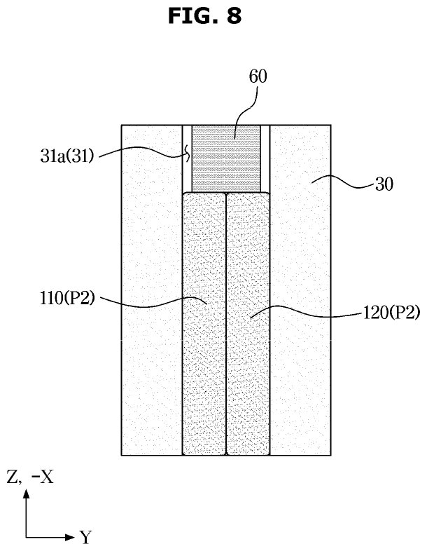

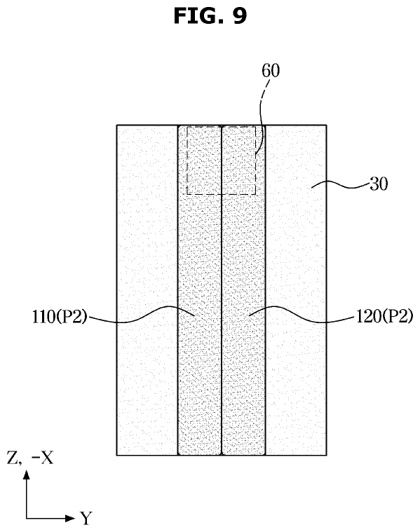

FIG. 7 is a schematic view illustrating the massage apparatus according to an embodiment of the disclosure. FIG. 8 is a schematic view illustrating the massage apparatus according to an embodiment of the disclosure. FIG. 9 is a schematic view illustrating the massage apparatus according to an embodiment of the disclosure. In particular, FIG. 7 shows the massage apparatus while the cover member is in the first position, and FIGS. 8 and 9 show the massage apparatus while the cover member is in the second position.

Referring to FIGS. 7 to 9, the cover member 100 may cover the opening 31. The cover member 100 may have the first position P1 and a second position P2. At the first position P1, the cover member 100 may open the opening 31 to allow the massage module 60 to be movable. The cover member 100 may cover the opening 31 at the second position P2. In addition, the cover member 100 may close the opening 31 at the second position P2. In the massage-on mode, the cover member 100 may be located at the first position P1, and in the massage-stop mode, the cover member 100 may be located at the second position P2.

The first cover member 110 may be located on the first side along the left-right direction of the opening 31 at the first position P1. The second cover member 120 may be located on the second side along the left-right direction of the opening 31 at the first position P1.

The cover member 100 may slide to cover the opening 31. For example, the cover member 100 may cover the opening 31 by sliding through a rack gear (not shown) and a pinion gear (not shown). Each of the rack gear (not shown) and the pinion gear (not shown) may be coupled to the base frame 30 or the seat frame 10a to cause the cover member 100 to slide to open and close the opening 31.

The cover member 100 may cover the opening 31 at the second position P2. For example, referring to FIG. 8, the cover member 100 may partially close and cover the opening 31 at the second position P2. While the cover member 100 partially closes the opening 31, the massage module 60 may be located at one end of the opening 31. For example, while the massage apparatus is used in the chair mode, the massage module 60 may be located at an upper end within the opening 31. In additionally, while the massage apparatus is used in the bed mode, the massage module 60 may be located at a rear end within the opening 31 (see FIG. 13).

Furthermore, for example, referring to FIG. 9, the cover member 100 may completely close and cover the opening 31 at the second position P2. The cover member 100 may be located between the seat portion 10 and the massage module 60 so as to cover the massage module 60. For example, while the massage apparatus is used in the chair mode, the cover member 100 may be positioned at a front side of the massage module 60 to completely close and cover the opening 31. At this time, the massage module 60 may be in a position that is moved backward from its position in the massage-on mode. In addition, while the massage apparatus is used in the bed mode, the cover member 100 may be positioned above the massage module 60 to completely close and cover the opening 31 (see FIG. 14).

The opening 31 is closed in the massage-stop mode, that is, at the second position P2 of the cover member 100, so that the user may not be pressed by the massage module 60 while not receiving a massage. Accordingly, the user may feel comfortable by the massage apparatus during the massage-stop mode. In addition, while the massage apparatus is in the bed mode and the massage-stop mode, the user may lie down on the massage apparatus and sleep comfortably.

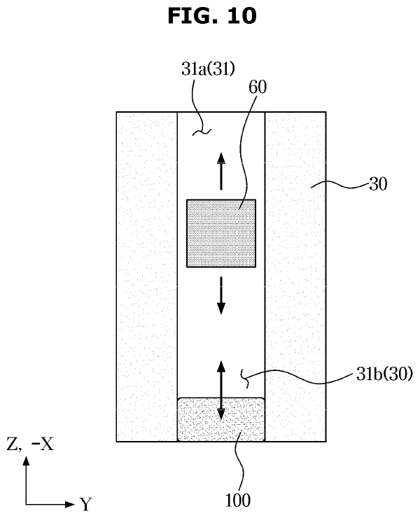

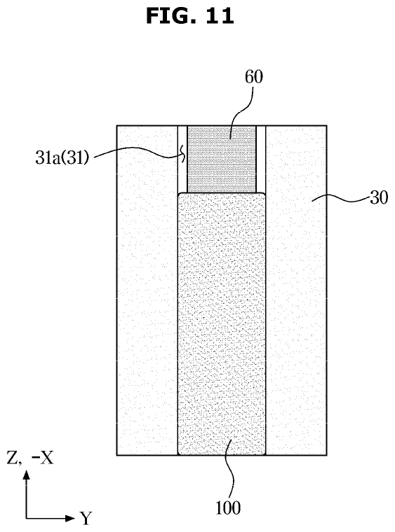

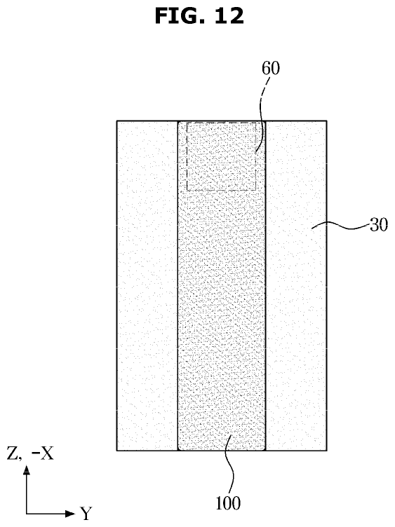

FIG. 10 is a schematic view illustrating the massage apparatus according to an embodiment of the disclosure. FIG. 11 is a schematic view illustrating the massage apparatus according to an embodiment of the disclosure. FIG. 12 is a schematic view illustrating the massage apparatus according to an embodiment of the disclosure. In particular, FIG. 10 shows the massage apparatus while the cover member is in the first position, and FIGS. 11 and 12 show the massage apparatus while the cover member is in the second position.

Referring to FIGS. 10 to 12, at the first position P1, the cover member 100 may open the opening 31 to allow the massage module 60 to be movable. The cover member 100 may cover the opening 31 at the second position P2. In addition, the cover member 100 may close the opening 31 at the second position P2. In the massage-on mode, the cover member 100 may be located at the first position P1, and in the massage-stop mode, the cover member 100 may be located at the second position P2.

The cover member 100 may be located at a second end 31b of the opening 31 at the first position P1. For example, while the massage apparatus is used in the chair mode, the cover member 100 may be positioned at a lower portion within the opening 31. In addition, while the massage apparatus is used in the bed mode, the cover member 100 may be positioned at a front end within the opening 31.

The cover member 100 may be in a folded state at the second end 31b of the opening 31 at the first position P1. The cover member 100 may be in an unfolded state from the second end 31b of the opening 31 toward the massage module 60 at the second position P2. For example, the cover member 100 may be in a stacked state at the first position P1, and the stacked state may be fully spread so as to close and cover the opening 31 at the second position P2.

For example, referring to FIG. 11, the cover member 100 may partially close and cover the opening 31 at the second position P2. The massage module 60 may be located at one end of the opening 31 while the cover member 100 partially closes the opening 31. For example, while the massage apparatus is used in the chair mode, the massage module 60 may be positioned at an upper portion within the opening 31. In addition, while the massage apparatus is used in the bed mode, the massage module 60 may be positioned at the rear end within the opening 31 (see FIG. 13).

Furthermore, for example, referring to FIG. 12, the cover member 100 may fully close and cover the opening 31 at the second position P2. The cover member 100 may be disposed between the seat portion 10 and the massage module 60 so as to cover the massage module 60. For example, while the massage apparatus is used in the chair mode, the cover member 100 may be disposed on the front side of the massage module 60 to completely close and cover the opening 31. At this time, the massage module 60 may be in a positioned that is moved backward from its position in the massage-on mode. In addition, while the massage apparatus is used in the bed mode, the cover member 100 may be positioned over the massage module 60 to completely close and cover the opening 31 (see FIG. 14).

The opening 31 is closed in the massage-stop mode, that is, at the second position P2 of the cover member 100, so that the user may not be pressed by the massage module 60 while not receiving a massage. Accordingly, the user may feel comfortable by the massage apparatus during the massage-stop mode. In addition, while the massage apparatus is in the bed mode and the massage-stop mode, the user may lie down on the massage apparatus and sleep comfortably.

FIG. 13 is a side cross-sectional view illustrating the massage apparatus according to an embodiment of the disclosure. FIG. 13 is a view showing the cover member covering the opening in the massage apparatus shown in FIGS. 6, 8, and 11. FIG. 14 is a side cross-sectional view illustrating the massage apparatus according to an embodiment of the disclosure. FIG. 14 is a view showing the cover member covering the opening in the massage apparatus shown in FIGS. 9 and 12.

Referring to FIG. 13, the cover member 100 may cover the opening 31. The cover member 100 may cover a portion of the opening 31 excluding a first end of the opening 31 on which the massage module 60 is located.

Referring to FIG. 14, the cover member 100 may cover the opening 31. The cover member 100 may cover the entire opening 31. For example, while the massage apparatus is in the bed mode, the massage module 60 may be moved downward. However, although the massage module 60 is not moved downward, the cover member 100 may cover the entire opening 31.

In the drawings, the massage apparatus is shown in the bed mode, but the cover member 100 may also cover and close the opening 31 while the massage apparatus is in the chair mode. For example, as shown in FIG. 14, while the massage apparatus is in the chair mode, the massage module 60 may be moved rearward. However, although the massage module 60 is not moved rearward, the cover member 100 may cover the entire opening 31.

The opening 31 is closed in the massage-stop mode, that is, at the second position P2 of the cover member 100, so that the user may not be pressed by the massage module 60 while not receiving a massage. Accordingly, the user may feel comfortable by the massage apparatus during the massage-stop mode. In addition, while the massage apparatus is in the bed mode and the massage-stop mode, the user may lie down on the massage apparatus and sleep comfortably.

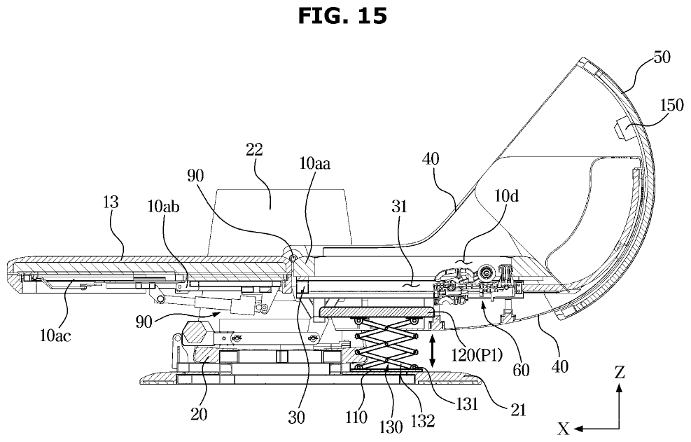

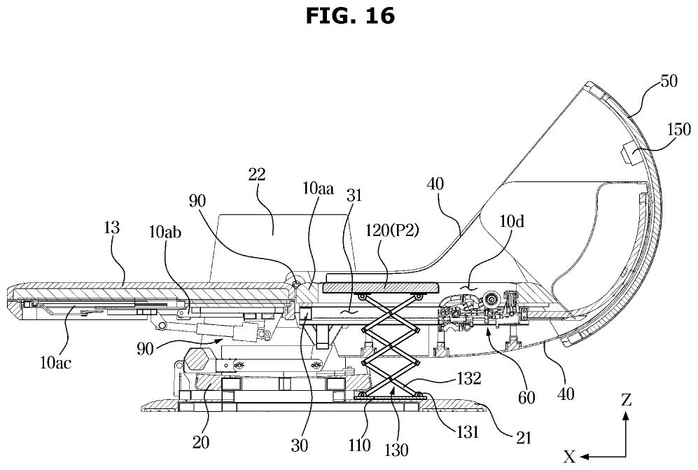

FIG. 15 is a side cross-sectional view illustrating the massage apparatus according to an embodiment of the disclosure. FIG. 16 is a side cross-sectional view illustrating the massage apparatus according to an embodiment of the disclosure. FIG. 15 shows the massage apparatus while the cover member is in the first position, and FIG. 16 shows the massage apparatus while the cover member is in the second position.

Referring to FIGS. 15 and 16, the cover member 100 may include the first cover member 110 and the second cover member 120.

The first cover member 110 may be spaced apart from the opening 31. For example, the first cover member 110 may be located on the floor 21 of the leg 20.

The second cover member 120 may be disposed between the first cover member 110 and the seat portion 10. For example, the second cover member 120 may be positioned above the first cover member 110 to open and close the opening 31.

The cover member 100 may further include a connecting member 130. The connecting member 130 may be disposed between the first cover member 110 and the second cover member 120. For example, the connecting member 130 may be disposed above the first cover member 110 and below the second cover member 120. The connecting member 130 may connect the first cover member 110 and the second cover member 120.

The connecting member 130 may include a connecting bar 131 and a rotary connecting portion 132. A plurality of connecting bars 131 may be provided. The plurality of connection bars 131 may be arranged along the vertical direction. Each of the connection bars 131 may be disposed inclined. The rotary connecting portion 132 may rotatably connect the plurality of connecting bars 131. The plurality of rotary connecting portions 132 may be provided.

However, the first cover member 110 may be eliminated. For example, the connecting member 130 may be directly coupled to the floor 21. At this time, the second cover member 120 may be referred to as the cover member 100.

The second cover member 120 may open the opening 31 at the first position P1. The second cover member 120 may close the opening 31 at the second position P2. The connecting member 130 may move the second cover member 120 from the first position P1 to the second position P2.

The opening 31 is closed in the massage-stop mode, that is, the second position P2 of the second cover member 120, so that the user may not be pressed by the massage module 60 while not receiving a massage. Accordingly, the user may feel comfortable by the massage apparatus during the massage-stop mode. In addition, while the massage apparatus is in the bed mode and the massage-stop mode, the user may lie down on the massage apparatus and sleep comfortably.

FIG. 17 is a control block view illustrating the massage apparatus according to an embodiment of the disclosure.

Referring to FIG. 17, the massage apparatus according to an embodiment may include the user interface 24. The user interface 24 may be provided as an operating device. The user may place the massage apparatus in the massage-on mode or the massage-stop mode through the user interface 24, and control a drive device 70 to move the cover member between the first position P1 for opening the opening 31 and the second position P2 for closing the opening 31. The user interface 24 may include the input interface and the output interface.

The massage apparatus according to an embodiment may include at least one sensor 150. The at least one sensor 150 may detect whether the user is sleeping. For example, the at least one sensor 150 may include a camera 150. For example, the camera 150 may be coupled to the cover 50, and while the cover 50 covers the first seating portion 11 the camera may detect whether the user is sleeping on the massage apparatus. However, the type and location of the sensor that detects whether the user is asleep is not limited to the above examples.

The at least one sensor 150 may transmit a detected value of the sensor to a controller 80 after detecting whether the user is asleep.

The massage apparatus according to an embodiment may include the controller 80. The controller 80 may receive an input signal from the user interface 24 and control the massage module 60 and/or the drive device 70. In addition, the controller 80 may transmit an output signal to the user interface 24. For example, the controller 80 may control the drive device 70 and/or the massage module 60 to the massage-on mode or the massage-stop mode based on the user input. The drive device 70 may move the cover member 100 to the first position P1 upon input of a massage-on mode signal, and move the cover member 100 to the second position P2 upon input of a massage-stop mode signal.

For example, when the user inputs the massage-on mode into the user interface 24, the controller 80 may receive a massage-on signal to allow the massage module 60 to operate. For example, the controller 80 may operate the massage module 60 by driving the motor 67.

Conversely, for example, when the user inputs the massage-stop mode into the user interface 24, the controller 80 may receive a massage-stop signal to cause the massage module 60 to stop. For example, the controller 80 may stop the massage module 60 by stopping the motor 67. At this time, the controller 80 may control the motor 67 of the drive device 70 so that the cover member 100 covers the opening 31.

Furthermore, the controller 80 may determine whether the user is asleep through a signal transmitted from the sensor 150. The controller 80 may switch the massage apparatus to the massage-on mode or the massage-stop mode, regardless of the user input. For example, upon determining that the user is sleeping, the controller 80 may switch the massage apparatus to the massage-stop mode and control the drive device 70 to allow the cover member 100 to be at the second position P2.

Furthermore, referring to FIG. 13, the massage module 60 may provide a pillow function for the user. The controller 80 may use the drive device 70 as in a conventional manner or a separate drive device to adjust the height at which the massage module 60 protrudes towards or away from the user.

The massage apparatus according to an embodiment may include the drive device 70. The drive device 70 may receive a signal from the controller 80 to move the cover member 100. The drive device 70 may allow the cover member 100 to open and close the opening 31. For example, the drive device 70 may operate a motor 71 to rotate or slide the first cover member 110 and the second cover member 120 from the first position P1 to the second position P2, so that the opening 31 may be opened and closed (see FIGS. 5 to 9). In addition, for example, the drive device 70 may operate the motor 71 to unfold the cover member 100 in the folded-state to close the opening 31 (see FIGS. 10 to 12). In addition, for example, the drive device 70 may operate the motor 71 so as to extend the connecting member 130 to move the second cover member 120 from the first position P1 to the second position P2 and close the opening 31 (see FIGS. 14 and 15).

In the massage apparatus according to one aspect of the disclosure, because the cover member 100 covers and closes the opening 31, no pressure is applied to the user by the massage module 60 even when the user is not receiving a massage, so that the user may relax comfortably.

According to one aspect of the disclosure, because the cover member 100 covers and closes the opening 31, the massage apparatus may allow the user to relax comfortably even while not receiving a massage, regardless of the chair mode and/or the bed mode.

The effects of one aspect of the disclosure are not limited to those mentioned above, and other effects not mentioned may be clearly understood by those skilled in the art from the following description.

The massage apparatus according to an embodiment may include the seat frame 10a, the first side 10b on which the seat coupled to the seat frame is disposed, and the second side 10c opposite to the first side, the base frame 30 disposed on the second side 10c of the seat portion 10 and including the opening 31, and the massage module 60 configured to provide a massage function and coupled to the base frame 30 so as to be disposed in the opening 31.

The massage apparatus according to an embodiment may include the cover member 100 movable to cover the opening 31 and disposed on the second side 10c of the seat portion 10.

In the massage apparatus according to an embodiment, the cover member may include a first position that opens the opening so that the massage module is movable, and a second position that closes the opening.

In the massage apparatus according to an embodiment, the cover member 100 may include the first cover member 110 disposed on the first side along the left-right direction of the opening at the first position P1, and the second cover member 120 disposed on the second side along the left-right direction of the opening at the first position P1.

In the massage apparatus according to an embodiment, each of the first cover member 110 and the second cover member 120 may be rotated and moved from the first position P1 to the second position P2, respectively.

In the massage apparatus according to an embodiment, each of the first cover member 110 and the second cover member 120 may be slidably moved from the first position P1 to the second position P2, respectively.

In the massage apparatus according to an embodiment, the cover member 100 may be folded from the one end 31a of the opening 31 at the first position P1, and may be unfolded from the one end 31a of the opening 31 towards the massage module 60 at the second position P2.

In the massage apparatus according to an embodiment, the massage module 60 may be located at the first end 31a of the opening 31 at the second position P2 of the cover member 100, and the cover member 100 may be provided from the second end 31b of the opening 31 to the massage module 60 at the second position P2.

In the massage apparatus according to an embodiment, the cover member 100 may be disposed between the seat portion 10 and the massage module 60 so as to cover the massage module 60 at the second position P2.

In the massage apparatus according to an embodiment, the cover member 100 may include the first cover member 110 spaced apart from the opening 31, the second cover member 120 disposed between the first cover member 110 and the seat portion 10, and the connecting member 130 disposed between the first cover member 110 and the second cover member 120 to connect the first cover member 110 and the second cover member 120.

The massage apparatus according to an embodiment may further include the drive device 70 provided to move the cover member 100 to the first position P1 to allow the opening 31 to be opened in the massage-on mode, and to move the cover member 100 to the second position P2 to allow the opening 31 to be covered in the massage-stop mode.

The massage apparatus according to an embodiment may further include the controller 80 configured to switch the drive device 70 to the massage-on mode or the massage-stop mode based on the user input.

In the massage apparatus according to an embodiment, the controller 80 may move the cover member 100 from the first position P1 to the second position P2 in response to switching from the massage-on mode to the massage-stop mode.

The massage apparatus according to an embodiment may further include the drive device 70 provided to move the cover member 100 to the first position P1 to allow the opening 31 to be opened in the massage-on mode and to move the cover member 100 to the second position P2 to allow the opening 31 to be covered in the massage-stop mode, and the controller 80 provided to control the drive device 70 to allow the connecting member 130 to extend toward the opening 31 so that the second cover member 120 covers the opening 31 in response to switching from the massage-on mode to the massage-stop mode.

The massage apparatus according to an embodiment may include the seat portion 10, the base frame 30 disposed on one side of the seat portion 10 and including the opening 31, the massage module 60 coupled to the base frame 30 so as to be disposed in the opening 31 and configured to provide a massage function, an opening/closing member 100 movable to open and close the opening 31, the opening/closing member 100 movable to open and close the opening 31, and the drive device 70 provided to move the opening/closing member.

In the massage apparatus according to an embodiment, the drive device 70 may move the opening/closing member 100 to the first position P1 to allow the opening 31 to be opened in the massage-on mode, and move the opening/closing member 100 to the second position P2 to allow the opening 31 to be covered in the massage-stop mode.

The massage apparatus according to an embodiment may further include the controller 80 provided to switch the drive device 70 to the massage-on mode or the massage-stop mode based on the user input.

In the massage apparatus according to an embodiment, the opening/closing member 100 may include the first opening/closing member 110 disposed on the first side along the left-right direction of the opening in the massage-on mode, and the second opening/closing member 120 disposed on the second side along the left-right direction of the opening in the massage-on mode.

In the massage apparatus according to an embodiment, the controller 80 may move each of the first opening/closing member 110 and the second opening/closing member 120 from the first position P1 to the second position (P2) in response to switching from the massage-on mode to the massage-stop mode.

In the massage apparatus according to an embodiment, the controller 80, in response to switching from the massage-on mode to the massage-stop mode, may move the massage module 60 to allow the massage module 60 to be located at the first end 31a of the opening 31, and extend the opening/closing member 100 from the second end 31b of the opening 31 to the first end 31a.

In the massage apparatus according to an embodiment, the opening/closing member 100 may include the first opening/closing member 110 spaced apart from the opening 31, the second opening/closing member 120 disposed between the first opening/closing member 110 and the seat portion 10, and the connecting member 130 disposed between the first opening/closing member 110 and the second opening/closing member 120 to connect the first opening/closing member 110 and the second opening/closing member 120.

In the massage apparatus according to an embodiment, the controller 80, in response to switching from the massage-on mode to the massage-stop mode, may extend the connecting member 130 towards the opening 31 so that the second opening/closing member 120 to cover the opening 31.

While the present disclosure has been particularly described with reference to exemplary embodiments, it should be understood by those of skilled in the art that various changes in form and details may be made without departing from the spirit and scope of the present disclosure.

1. A massage apparatus, comprising:
a seat portion with a first side and a second side opposite the first side, the seat portion including:
a seat frame, and
a seat on the first side of, and coupled to, the seat frame;
a base frame on the second side of the seat portion, and including an opening;
a massage module coupled to the base frame, and configured to provide a massage function through the opening; and
a cover member on the second side of the seat portion,
wherein the cover member is configured to be movable to cover the opening and uncover the opening.

2. The massage apparatus of claim 1, wherein
the cover member is movable between a first position that opens the opening so that the massage module is movable through the opening, and a second position that closes the opening.

3. The massage apparatus of claim 2, wherein
the cover member includes:
a first cover member disposed on a first side of the opening along a left-right direction when the cover member is at the first position, and
a second cover member disposed on a second side of the opening along the left-right direction when the cover member is at the first position.

4. The massage apparatus of claim 3, wherein
each of the first cover member and the second cover member is rotatable so as to be moved from the first position to the second position.

5. The massage apparatus of claim 3, wherein
each of the first cover member and the second cover member is slidable so as to be moved from the first position to the second position.

6. The massage apparatus of claim 2, wherein
the cover member is folded at a first end of the opening when the cover member is at the first position, and is unfolded from the first end of the opening towards a second end of the opening when the cover member is at the second position.

7. The massage apparatus of claim 5, wherein
when the cover member is at the second position, the cover member is located at a first end of the opening, and the massage module is located at a second end of the opening.

8. The massage apparatus of claim 5, wherein
at the second position, the cover member is disposed between the seat portion and the massage module so as to cover the massage module.

9. The massage apparatus of claim 1, wherein
the cover member includes:
a first cover member spaced apart from the opening,
a second cover member between the first cover member and the seat portion, and
a connecting member disposed between the first cover member and the second cover member to connect the first cover member and the second cover member.

10. The massage apparatus of claim 4, further comprising:
a drive device configured to:
move the cover member to the first position to uncover the opening in a massage-on mode, and
move the cover member to the second position to cover the opening in a massage-stop mode.

11. The massage apparatus of claim 10, further comprising:
a controller configured to switch the drive device to the massage-on mode and the massage-stop mode based on a user input.

12. The massage apparatus of claim 11, wherein
the controller is configured to move the cover member from the first position to the second position in response to switching from the massage-on mode to the massage-stop mode.

13. The massage apparatus of claim 9, further comprising:
a drive device configured to:
move the cover member to a first position to uncover the opening in a massage-on mode, and
move the cover member to a second position to cover the opening in a massage-stop mode; and
a controller configured to:
control, in response to switching from the massage-on mode to the massage-stop mode, the drive device to extend the connecting member toward the opening so that the second cover member covers the opening.

14. The massage apparatus of claim 6, wherein
when the cover member is at the second position, the cover member is located at a first end of the opening, and the massage module is located at a second end of the opening.

15. The massage apparatus of claim 6, wherein
at the second position, the cover member is disposed between the seat portion and the massage module so as to cover the massage module.
